(19) United States
(12) Patent Application Publication
(10) Pub. No.: US 2006/0187175 A1
(43) Pub. Date: Aug. 24, 2006

(54) Method of arranging embedded gate driver circuit for display panel

(75) Inventors: Shin-Tai Lo, Miaoli City (TW); Yi-Chin Lin, Taichung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/062,426

(22) Filed: Feb. 23, 2005

(51) Int. Cl. G09G 3/36

(52) U.S. Cl. 345/100

(57) ABSTRACT

A method of arranging an embedded gate driver circuit for a display panel having a screen area is provided by the invention. The method comprises causing a gate line G(i) in the screen area associated with each shift register SR(i) to serve as a line for transmitting signal to both a next shift register SR(i+1) and a previous shift register SR(i−1), dividing the shift registers SR(i) into two units wherein the number of the shift registers SR(i) of one unit is the same as that of the other, disposing both units at left and right sides of the screen area respectively, interconnecting one shift register SR(i) at the left side and a corresponding shift register SR(i+1) at the right side by gate lines G(i) and G(i+1), and feeding first and second clock signals CLK and CLKB to the shift registers SR(i) at both sides simultaneously.

### FIELD OF THE INVENTION

The present invention relates to circuit layouts and more particularly to an improved method of arranging an embedded gate driver circuit for an LCD (liquid crystal display) panel, OLED (organic light-emitting display) panel, or the like.

### BACKGROUND OF THE INVENTION

TFT (thin film transistor) technology has progressed rapidly in recent years as detailed below. For a SOG (system on glass) display technology, a-Si (amorphous silicon) processes and LTPS (low temperature poly-silicon) processes are employed. A difference between LTPS TFT and a-Si TFT is that the former employs poly-silicon and the latter employs amorphous silicon. LTPS TFT has higher carrier mobility but is a complicated process. To the contrary, a-Si TFT has lower carrier mobility and a simple process. Moreover, the process of a-Si TFT is relatively mature. As such, a-Si TFT is still advantageous in consideration of its low cost.

Additionally, embedded gate driver circuits, data multiplexers, image signal driver circuits, and even memory units are incorporated in a display panel in recent years. As such, an optimum layout is required.

Properties of TFT devices are closely associated with materials and process conditions. Moreover, W/L (width to length) ratio (i.e., transistor size) is an important factor in designing TFT device. Typically, a single circuit is comprised of a plurality of TFT devices. Thus, an optimum layout is required so as to create a desired performance of driver circuit in a limited space. This is one of the most important issues in circuit design.

A prior display panel 10 having an embedded gate driver circuit 20 is shown FIG. 1. The embedded gate driver circuit 20 is comprised of a plurality of TFT devices. The embedded gate driver circuit 20 is adapted to transmit signal to gate lines G1, G2, G3, . . . , Gn associated with data lines S1, S2, S3, . . . , Sm when driving pixels on a screen area 11 of the display panel 10. The prior embedded gate driver circuit 20 is shown in FIG. 2. It comprises a plurality of shift registers SR1, SR2, SR3, . . . , SR8 coupled in series in which an input pin IN of the i-th shift register SR(i) is coupled to a gate line G(i−1) at an immediately previous output pin OUT. The ith shift register SR(i) is enabled by a driving signal from the gate line G(i−1). A reset pin (RT) of the i-th shift register SR(i) is coupled to a gate line G(i+1) at an output pin OUT of an immediately next shift register SR (i+1). The i-th shift register SR(i) is reset by a driving signal from the gate line G(i+1).

However, the prior embedded gate driver circuit 20 suffered from several disadvantages. For example, layout of the embedded gate driver circuit 20 involves that all gate driver circuits 20 are placed at one side of the display panel 10. Typically, an increased W/L ratio of transistor is required for a long operating time in a gate driver circuit design phase. Unfortunately, there is no additional space available for the increase since the size of the display panel 10 is fixed. This is best illustrated in the left side of the display panel 20 of FIG. 1 (i.e., no additional space available).

Moreover, it is known that resolution of a display panel is gradually increased as technology advances. The prior layout of embedded gate driver circuit 20 forces a single stage of gate driver circuit to dispose in a reduced area. However, it is impossible of obtaining a sufficient driving of a gate signal since the area occupied is very small.

In addition, the layout of the embedded gate driver circuit 20 as shown in FIG. 1 involves that all gate driver circuits 20 are placed at one side of the display panel 10. One shift register is enabled by both an output signal from a previous stage and reset by an output signal from a next stage. As such, crossover may occur at a gate line associated with each shift register as shown in FIG. 2. Crossover not only generates parasitic capacitance but also increases complexity of the layout.

For overcoming the above disadvantages, a document entitled “ASG (amorphous silicon TFT gate driver circuit) Technology for Mobile TFT-LCD panel” is disclosed in IDRC & IMID 2004 by Samsung Company. A double ASG is discussed in the document as shown in FIG. 3. Two independent embedded gate driver circuits 31 and 32 are disposed at both sides of a screen area 30 in which one driver circuit has clock signals VCK1_O, VCK2_O, VCK1_E, and VCK2_E, and start signals VST_O and VST_E different from each other. This can decrease a dead space of the panel. However, two independent groups of clock signals VCK1_O, VCK2_O, VCK1_E, and VCK2_E, and start signals VST_O and VST_E are required, resulting in an increase in the manufacturing cost. Hence, a need for improvement exists.

### SUMMARY OF THE INVENTION

It is an object of the present invention to provide a method of arranging an embedded gate driver circuit for a display panel so as to increase layout area of the embedded gate driver circuit, place more transistors in the embedded gate driver circuit, increase W/L ratio of transistor, enhance driving capability of the embedded gate driver circuit, increase useful life of the embedded gate driver circuit, and make the embedded gate driver circuit more reliable.

It is another object of the present invention to provide a novel layout of embedded gate driver circuit for a display panel so as to meet or satisfy the trend of resolution of the display panel being gradually increased, area occupied by a single stage of embedded gate driver circuit being decreased, and a single stage of embedded gate driver circuit being required to dispose in a reduced area.

It is yet another object of the present invention to provide a method of preventing crossover from occurring at a gate line.

It is a further object of the present invention to feed a first clock signal and a second clock signal to the shift registers at both side of the screen area simultaneously. That is, the number of control signals is only half of that disclosed in a prior method by Samsung Company which discloses two groups of independent clock signals and start signals.

To achieve the above and other objects, the present invention provides a method of arranging an embedded gate driver circuit for a display panel having a screen area. The method comprises causing a gate line in the screen area associated with each shift register to serve as a line for transmitting signal to both a next shift register and a previous shift register, dividing the shift registers into two units wherein the number of the shift registers of one unit is the same as that of the other, disposing both units at left and right sides of the screen area respectively, interconnecting one shift register at the left side and a corresponding shift register at the right side by two gate lines, and feeding first and second clock signals to the shift registers at both sides simultaneously. By utilizing the present invention, layout area can be increased without increasing the number of signal lines, more transistors are able to place in the embedded gate driver circuit, W/L ratio of transistor is increased, driving capability of embedded gate driver circuit is enhanced, useful life of embedded gate driver circuit is increased, and embedded gate driver circuit is more reliable.

The above and other objects, features and advantages of the present invention will become apparent from the following detailed description taken with the accompanying drawings.

### BRIEF DESCRIPTION OF THE DRAWINGS

FIG. 1 is a schematic drawing of a conventional display panel incorporating an embedded gate driver circuit.

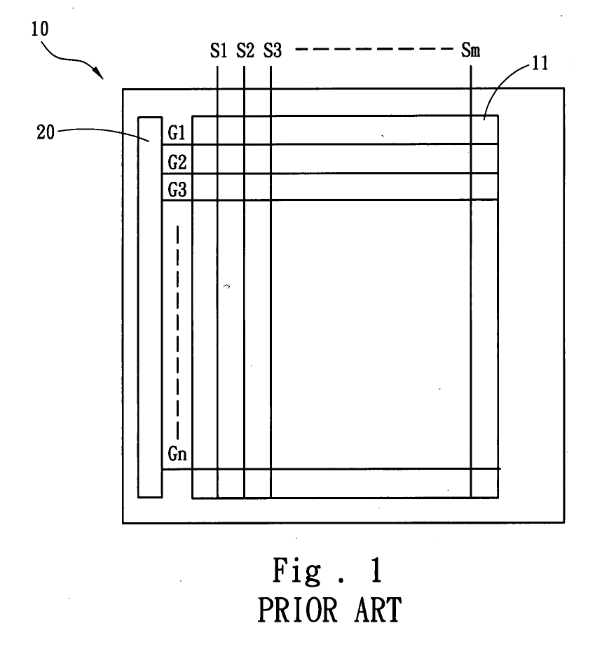

FIG. 2 is a circuit diagram of the gate driver circuit of FIG. 1.

FIG. 3 is a circuit diagram of another conventional display panel incorporating a double ASG.

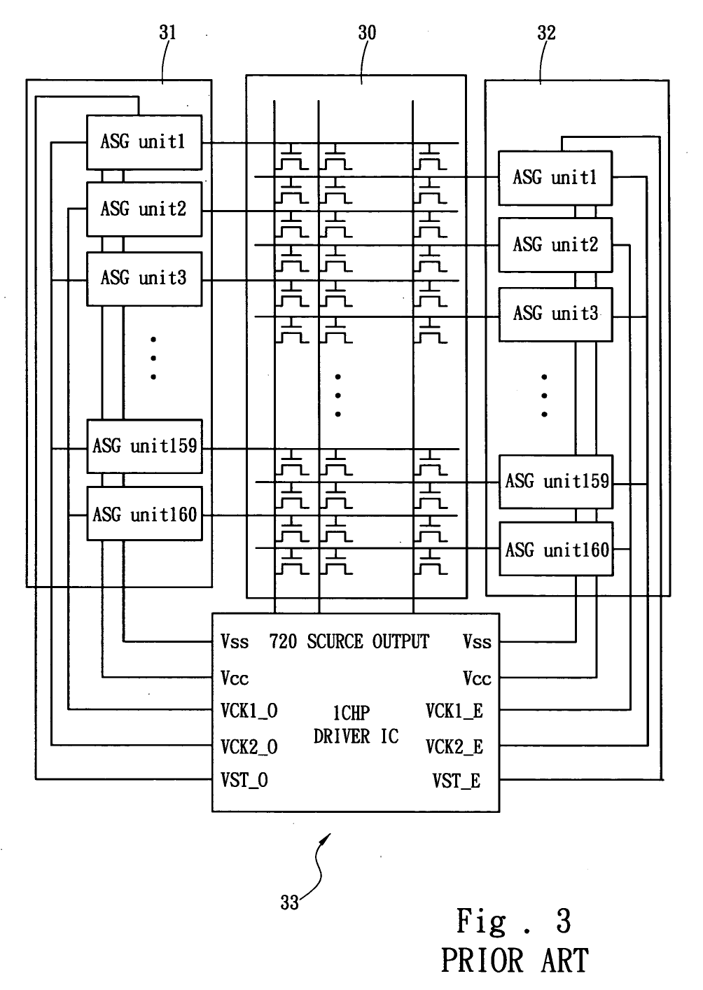

FIG. 4 is a circuit diagram of a gate driver circuit of a first preferred embodiment of the invention incorporated in a display panel; and

FIG. 5 is a circuit diagram of a gate driver circuit of a second preferred embodiment of the invention incorporated in a display panel.

### DETAILED DESCRIPTION OF THE PREFERRED EMBODIMENTS

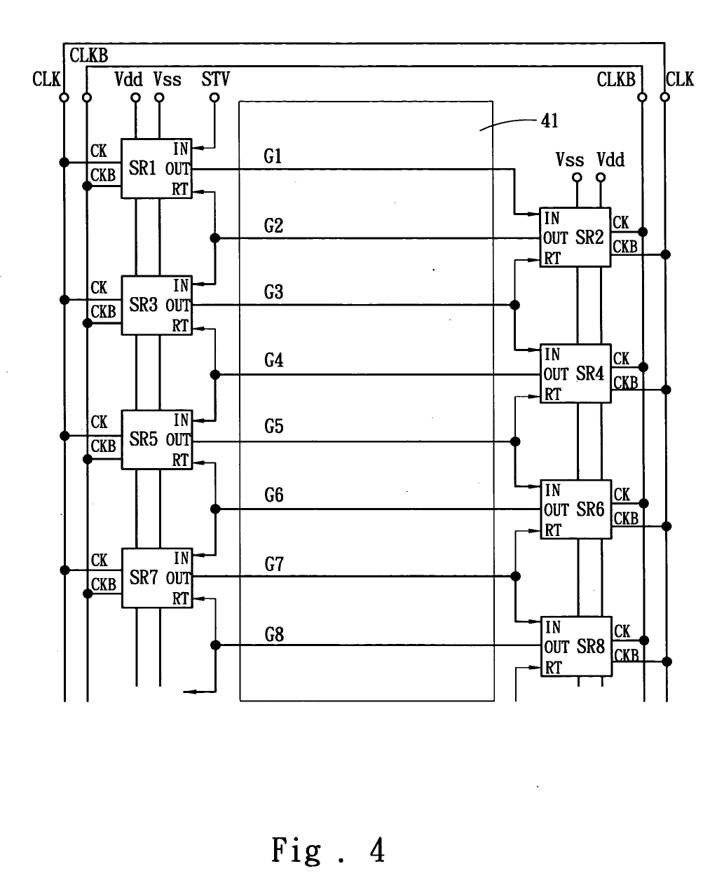

Referring to FIG. 4, there is illustrated a method of arranging an embedded gate driver circuit for a display panel in accordance with a first preferred embodiment of the invention. The display panel is an LCD panel or OLED panel. An a-Si TFT or LTPS TFT is employed to carry out the layout of the embedded gate driver circuit. The characteristic of the invention is that a gate line G(i) in a screen area 41 is employed by each shift register SR(i) as a line for transmitting signal to both an immediate next shift register SR(i+1) and an immediate previous shift register SR(i−1). Each pair of shift registers SR(i) and SR(i+1) of the gate driver circuit are disposed at left and right sides of a screen area 41 respectively where i is an odd number (e.g., i=1, 3, 5, or 7 in the embodiment). Moreover, gate lines G(i) and G(i+1) are interconnected each pair of shift registers SR(i) and SR(i+1). Together they form an S shape.

In detail, for the shift registers SR1, SR2, SR3, . . . , SR8 an input pin IN of the i-th shift register SR(i) at one side of the screen area 41 is coupled to an output pin OUT of a previous shift register SR(i−1) via a gate line G(i−1). The i-th shift register SR(i) is thus enabled by a driving signal transmitted over the gate line G(i−1). A reset pin RT of the i-th shift register SR(i) is coupled to an output pin OUT of a next shift register SR (i+1) at the other side of the screen area 41 via a gate line G(i+1). The i-th shift register SR(i) is thus reset by a driving signal transmitted over the gate line G(i+1). Further, a first clock signal CLK and a second clock signal CLKB are fed to the shift registers SR(i) at both sides of the screen area 41 simultaneously.

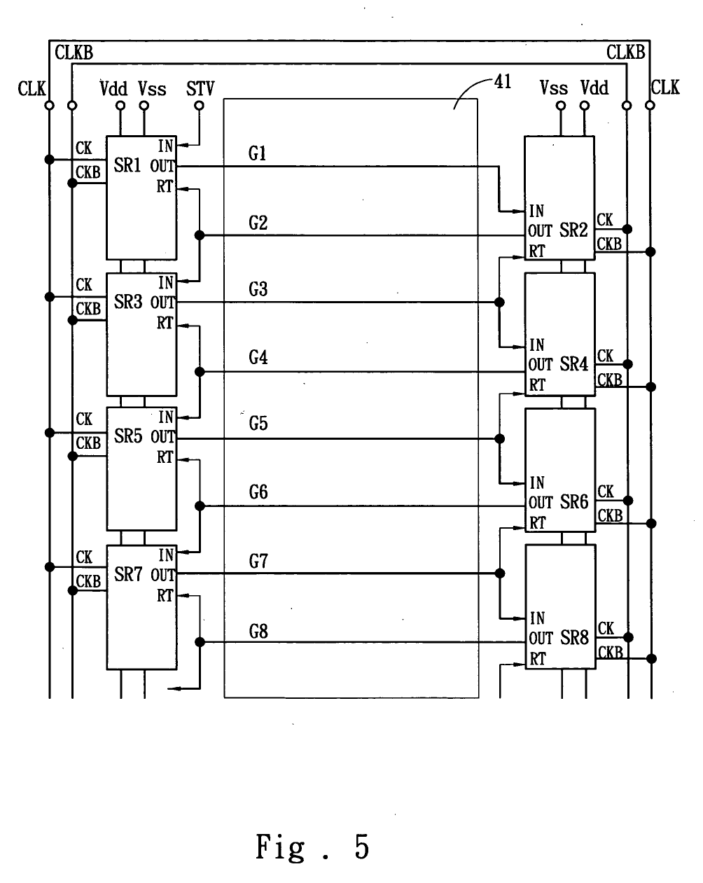

Referring to FIG. 5 in conjunction with FIG. 4, a second preferred embodiment of the invention is shown. Each pair of shift registers SR(i) and SR(i+1) of the embedded gate driver circuit are disposed at left and right sides of a screen area 41 respectively where i is an odd number (e.g., i=1, 3, 5, or 7 in the embodiment). This is the same as the first embodiment. The characteristics of the second preferred embodiment are detailed below. It is known that all shift registers SR(i) are disposed at the same side of the screen area 41 in the prior art. This means that space occupied by the shift registers SR(i+1) (where i is an odd number (e.g., i=1, 3, 5, or 7) are empty. As such, area of each shift register SR(i) (e.g., i=1, 2, 3, 4, 5, 6, 7 and 8 in the embodiment) is increased two times as compared with prior art (see FIG. 5).

The method of arranging an embedded gate driver circuit for a display panel in accordance with the invention is characterized in that the prior layout of embedded gate driver circuit is transformed into a layout of S shape. Also, a gate line G(i) at the screen area 41 is employed by each shift register SR(i) as a line for transmitting signal to both an immediate next shift register SR(i+1) and an immediate previous shift register SR(i−1). Each pair of shift registers SR(i) and SR(i+1) of the gate driver circuit are disposed at left and right sides of a screen area 41 respectively where i is an odd number (e.g., i=1, 3, 5, or 7 in the embodiment). Moreover, gate lines G(i) and G(i+1) are interconnected each pair of shift registers SR(i) and SR(i+1). Together they form an S shape.

As compared with prior art, the benefits of the invention include:

(1) The embedded gate driver circuit is comprised of a plurality of TFT devices. Thus, impedance of transistors is increased as time passed in operation because properties of a-Si TFT devices are subject to the adverse effect of bias. For overcoming this problem, the W/L ratio of transistor is required to increase for a long operating time in the design phase. Advantageously, the layout of the invention can significantly increase layout area of embedded gate driver circuit in a single stage. For example, as shown in FIG. 5 area of each shift register SR(i) is increased two times as compared with prior art. As a result, more transistors are able to place in the embedded gate driver circuit, W/L ratio of transistor is increased, driving capability of embedded gate driver circuit is enhanced, useful life of embedded gate driver circuit is increased, and embedded gate driver circuit is more reliable.

(2) Resolution of a display panel is gradually increased as technology advances. That is, area occupied by a pixel is decreased. A single stage of embedded gate driver circuit is required to dispose in a reduced area. Advantageously, the layout of the invention can increase area of each shift register SR(i) to two times as compared with prior art. The prior drawbacks of limited space for placing transistors as well as limited layout area are eliminated. As a result, the trend of increasing resolution of a display panel can be met.

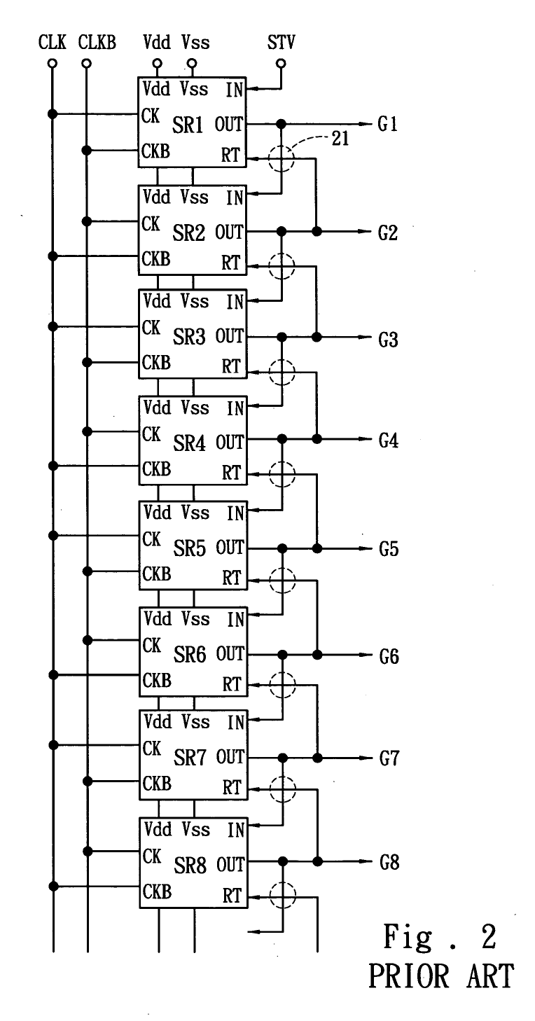

(3) The prior layout of the embedded gate driver circuit as shown in FIG. 2 involves that all gate driver circuits 20 are placed at one side of the display panel 10. One shift register is enabled by both an output signal from a previous shift register and an output signal from a next shift register. As such, crossover may occur at a gate line associated with each shift register. Crossover not only generates parasitic capacitance but also increases complexity of the layout. Advantageously, the layout of the invention involves that a gate line G(i) at a screen area 41 is employed by each shift register SR(i) as a line for transmitting signal to both an immediate next shift register SR(i+1) and an immediate previous shift register SR(i−1). Each pair of shift registers SR(i) and SR(i+1) of the gate driver circuit are disposed at left and right sides of a screen area 41 respectively where i is an odd number (e.g., i=1, 3, 5, or 7). Moreover, gate lines G(i) and G(i+1) are interconnected each pair of shift registers SR(i) and SR(i+1). Together they form an S shape. Such can prevent crossover from occurring. Further, the layout can be made simple.

(4) As compared with the document disclosed by Samsung Company, the invention involves that a gate line G(i) at a screen area 41 is employed by each shift register SR(i) as a line for transmitting signal to both an immediate next shift register SR(i+1) and an immediate previous shift register SR(i−1). Each pair of shift registers SR(i) and SR(i+1) of the embedded gate driver circuit are disposed at left and right sides of a screen area 41 respectively where i is an odd number (e.g., i=1, 3, 5, or 7). In other words, only a single gate driver circuit is sufficient. Moreover, the first clock signal CLK and the second clock signal CLKB are fed to the shift registers SR(i) at both side of the screen area 41 simultaneously. The number of control signals is only half of that disclosed in the document. That is, taking advantage of existing transistor devices for driving is sufficient. As an end, there is no increase in the manufacturing cost. Also, signal line arrangement is made simple.

While the invention herein disclosed has been described by means of specific embodiments, numerous modifications and variations could be made thereto by those skilled in the art without departing from the scope and spirit of the invention set forth in the claims.

What is claimed is:

1. A method of arranging an embedded gate driver circuit for a display panel having a screen area, the method comprising the step of:
causing a gate line G(i) in the screen area associated with one of a plurality of shift registers SR(i) to serve as a line for transmitting signal to both a next shift register SR(i+1) and a previous shift register SR(i−1).

2. The method of arranging an embedded gate driver circuit for a display panel having a screen area of claim 1, further comprising the steps of:
dividing the shift registers SR(i) into two units wherein the number of the shift registers SR(i) of one unit is the same as that of the other; and
disposing both units at left and right sides of the screen area respectively.

3. The method of arranging an embedded gate driver circuit for a display panel having a screen area of claim 2, further comprising the step of:
interconnecting one of the shift registers SR(i) at the left side and a corresponding one of the shift registers SR(i+1) at the right side by gate lines G(i) and G(i+1) so as to form an S shape.

4. The method of arranging an embedded gate driver circuit for a display panel having a screen area of claim 2, further comprising the step of:
feeding a first clock signal CLK and a second clock signal CLKB to the shift registers SR(i) at both sides of the screen area 41 simultaneously.
